(19) United States
(12) Patent Application Publication
(10) Pub. No.: US 2016/0042369 A1
(43) Pub. Date: Feb. 11, 2016

(54) DYNAMIC CO-OPTIMIZATION MANAGEMENT FOR GRID SCALE ENERGY STORAGE SYSTEM (GSESS) MARKET PARTICIPATION

(71) Applicant: NEC Laboratories America, Inc., Princeton, NJ (US)

(72) Inventors: Babak Asghari, San Jose, CA (US); Ratnesh K. Sharma, Fremont, CA (US)

(21) Appl. No.: 14/821,163

(22) Filed: Aug. 7, 2015

Related U.S. Application Data
(60) Provisional application No. 62/034,847, filed on Aug. 8, 2014.

(51) Int. Cl. G06Q 30/02

(52) U.S. Cl. CPC G06Q 30/0202

(57) ABSTRACT

A system and method for controlling operation of one or more grid scale energy storage systems (GSESSs). The method includes generating at least one time series model to provide forecasted pricing data for a plurality of markets, determining a reserve capacity for the one or more GSESSs to provide one or more real-time operation services, determining battery life and degradation costs for one or more batteries in the one or more GSESSs to provide battery life and degradation costs, and optimizing bids for the plurality of markets to generate optimal bids based on at least one of the forecasted pricing data, the battery life and degradation costs and the reserve capacity.

### RELATED APPLICATION INFORMATION

This application claims priority to provisional application Ser. No. 62/034,847 filed on Aug. 8, 2014, which is incorporated herein by reference.

### BACKGROUND

1. Technical Field

The present disclosure relates to grid scale energy storage systems (GSESS). More particularly, the present disclosure is related to a dynamic co-optimization management system for controlling a grid scale energy storage system for multiple markets considering wear cost and capacity for market-independent real-time operation.

2. Description of the Related Art

A power grid is an interconnected network typically comprising generating stations that produce electrical power (e.g., electricity), high-voltage transmission lines that carry the electrical power to demand centers, and distribution lines to deliver the electrical power to consumers and/or customers. However, unless additional support systems are in place, electricity must be used as it is being generated. In addition, power grids must have the ability to adapt between energy production and energy consumption, both of which vary drastically over time due to constantly varying demand.

Electricity generation and supply, as well as the markets, are evolving rapidly to be smarter and more responsive. In addition, the increasing penetration of renewable energy requires improved capabilities with regards to power quality and capacity. Storage systems coupled to the power grid allow for these capabilities, as well as compensating for fluctuations in power production and consumption. Abundance of intermittent renewable energy resources and bi-directional power flow in the power grid have increased the role of storage systems as grid stabilizers. Furthermore, deregulation of the energy industry supported by the evolution of markets and services has increased the interest of private electricity suppliers to invest in storage systems. However, installation and operation of storage systems are expensive to install and maintain, which is generally referred to as degradation and/or wear cost of the respective storage system.

Research on forecasting electricity prices has focused on techniques including employment of neural networks, principle component analysis, averaged Monte Carlo simulations, and time series modeling, and such techniques have not been employed for participation in energy markets.

### SUMMARY

According to an aspect of the present principles, a computer implemented method for controlling operation of one or more grid scale energy storage systems (GSESSs) is provided. The method includes generating at least one time series model to provide forecasted pricing data for a plurality of markets, determining a reserve capacity for the one or more GSESSs to provide one or more real-time operation services, determining battery life and degradation costs for one or more batteries in the one or more GSESSs to provide battery life and degradation costs, and optimizing bids for the plurality of markets to generate optimal bids based on at least one of the forecasted pricing data, the battery life and degradation costs and the reserve capacity.

According to another aspect of the present principles, a system for controlling operation of one or more grid scale energy storage systems (GSESSs) is provided. The system includes a forecaster configured to generate at least one time series models to provide forecasted pricing data for a plurality of markets, a capacity determiner configured to determine a reserve capacity for the one or more GSESSs to provide one or more real-time operation services, a battery life/degradation cost determiner configured to determine battery life and degradation costs for one or more batteries in the one or more GSESSs to provide battery life and degradation costs, and an optimizer configured to generate optimal bids based on at least one of the forecasted pricing data, the battery life and degradation costs and the reserve capacity.

According to another aspect of the present principles, a computer-readable storage medium comprising a computer readable program, wherein the computer readable program when executed on a computer causes the computer to perform the steps of generating at least one time series model to provide forecasted pricing data for a plurality of markets, determining a reserve capacity for the one or more GSESSs to provide one or more real-time operation services, determining battery life and degradation costs for one or more batteries in the one or more GSESSs to provide battery life and degradation costs, and optimizing bids for the plurality of markets to generate optimal bids based on at least one of the forecasted pricing data, the battery life and degradation costs and the reserve capacity.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles;

FIG. 2 shows an exemplary method for dynamically controlling grid scale energy storage systems (GSESSs), in accordance with an embodiment of the present principles;

FIG. 3 shows an exemplary method for forecasting pricing data for grid scale energy storage systems (GSESSs), in accordance with an embodiment of the present principles;

FIG. 4 shows an exemplary system for controlling grid scale energy storage systems (GSESSs), in accordance with an embodiment of the present principles; and

FIG. 5 shows an exemplary system for controlling grid scale energy storage systems (GSESSs), in accordance with an embodiment of the present principles.

### DETAILED DESCRIPTION OF PREFERRED EMBODIMENTS

The present principles are directed to system and methods for dynamic co-optimization management for controlling grid scale energy storage systems (GSESSs) for participation in multiple markets. When considering multiple GSESS services, coordinated scheduling and co-optimization of services to achieve maximum revenue is necessary. Factors, such as independent system operators (ISOs) and utilities guidelines, on GSESS deployment as well as market prices for different services in each region may be used to determine which services are well suited for co-optimization.

In an embodiment, a time series based market price forecasting engine may be employed to schedule a grid scale energy storage system (GSESS) for participating in multiple markets in a power grid to provide maximum revenue, according to the present principles. The time series based market price forecasting engine may consider multiple revenue streams from a plurality of markets. Forecasted pricing data may be employed in conjunction with a battery degradation cost to schedule grid scale energy storage system (GSESS) for participation in a plurality of markets, including energy markets and frequency regulation markets, to prevent any financial losses or impact on the optimal schedule of the GSESS in multiple markets.

In a further embodiment, the method, system, and computer program product provided herein may schedule GSESS storage for participation in multiple markets by determining the GSESS capacity for real-time operation of a voltage regulation service. In a particularly useful embodiment, a portion of GSESS capacity may be excluded from market co-optimization. This enables the GSESS to generate substantial revenue from the plurality of markets, including the energy market and the frequency regulation (FR) market, and also provides additional services to the energy grid as a voltage regulation provider in some embodiments.

In an embodiment, co-optimization may be employed to schedule the GSESS charge and discharge operations to maximize GSESS revenue from participating in energy market and reserve markets (e.g., including frequency regulation (FR) market). Advantageously, co-optimization may maximize GSESS revenue from participating in different markets according to the present principles.

In an embodiment, battery life and degradation costs associated with GSESS operations are considered and included when performing co-optimization. Battery life and degradation costs may result in a considerable impact on the optimal schedule of GSESS in the markets. Dynamic constraints for market scheduling and operation may be employed to achieve co-optimization according to some embodiments of the present principles. To participate in day-ahead electricity markets and yield optimal revenues, a forecast or estimate of day-ahead prices may be employed.

Prices in different electricity markets (e.g., energy market, frequency regulation market, etc.) are known only after energy bids clear, and as such, the price forecasting engine according the present principles may be employed to participate in markets optimally. In an embodiment, the price forecasting may include a time series based forecasting method that is computationally fast to provide forecasted pricing data.

It should be noted that the various embodiments in connection with grid scale electric energy storage systems disclosed herein are mostly described in terms of a battery. However it should be understood that other types of electric energy storage systems, such as batteries, accumulators, capacitors, compressed air energy storage, flywheel energy storage, thermal energy storage, etc., are within the scope of the present principles. It should also be understood that embodiments described herein may be entirely hardware or may include both hardware and software elements, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (“RAM”), a read-only memory (“ROM”), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

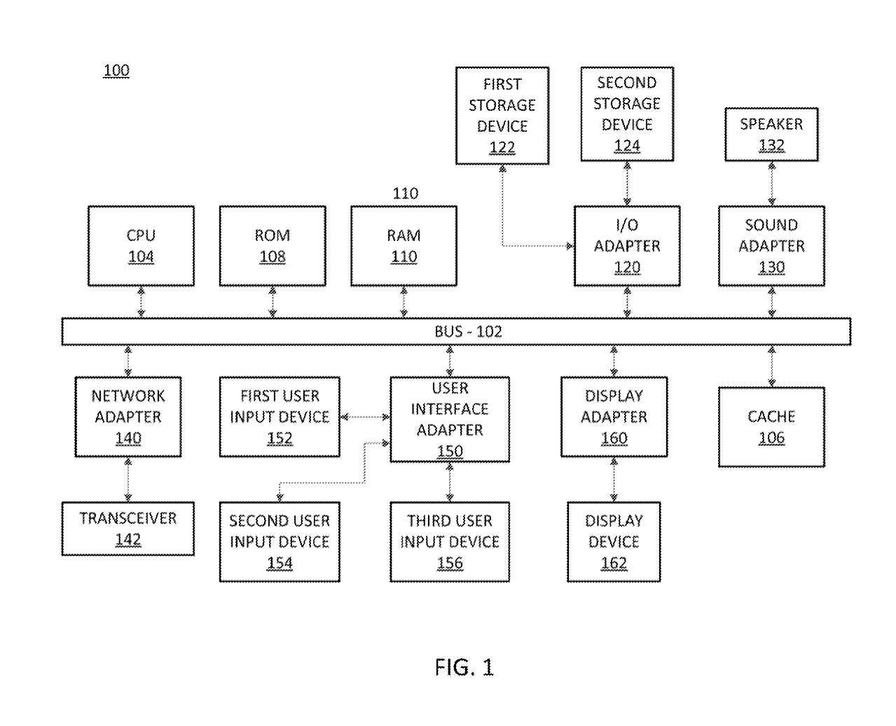

Referring to the drawings in which like numerals represent the same or similar elements and initially to FIG. 1, an exemplary processing system 100, to which the present principles may be applied, is illustratively depicted in accordance with an embodiment of the present principles. The processing system 100 includes at least one processor 104, such as a computer processor unit (CPU), operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Other types of input devices can also be used, while maintaining the spirit of the present principles. The user input devices 152, 154, and 156 can be the same type of user input device or different types of user input devices. The user input devices 152, 154, and 156 are used to input and output information to and from system 100.

The processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

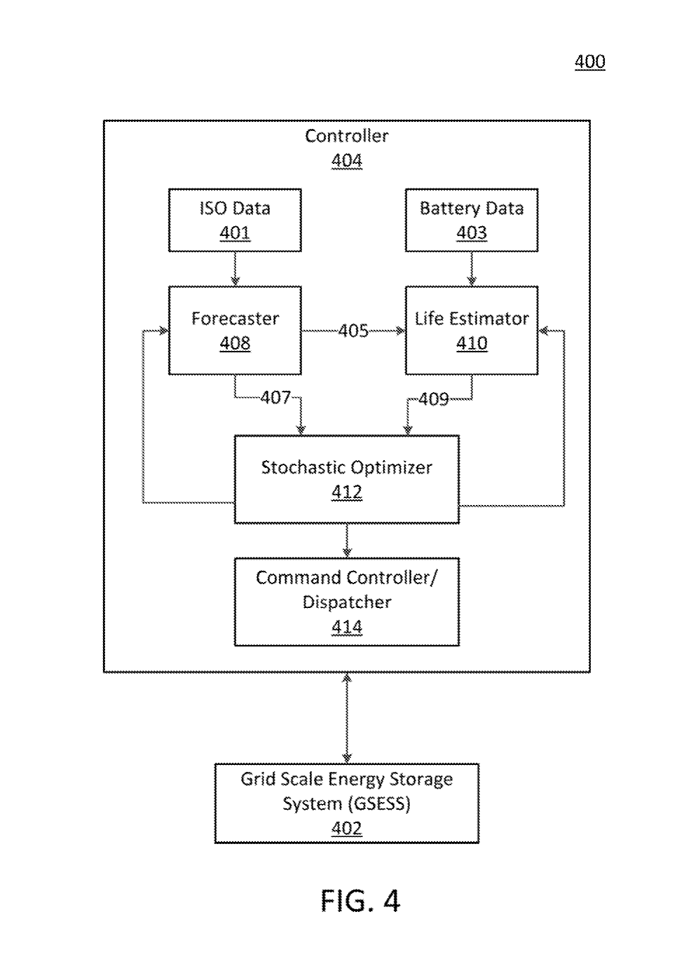

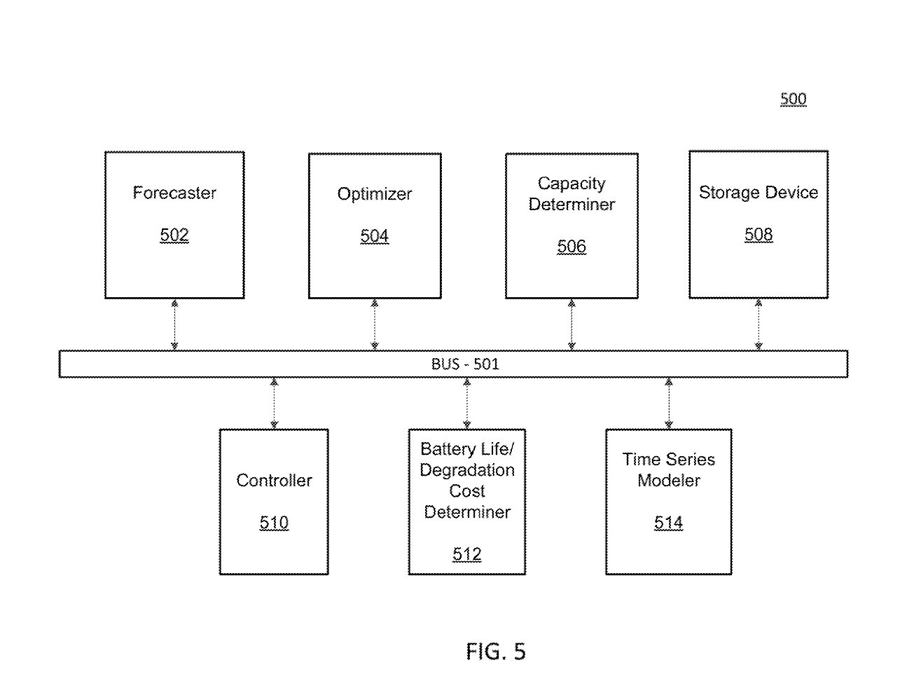

Moreover, it is to be appreciated that systems 400 and 500 described below with respect to FIGS. 4 and 5, respectively, is a system for implementing respective embodiments of the present principles. Part or all of processing system 100 may be implemented in one or more of the elements of systems 400 and 500.

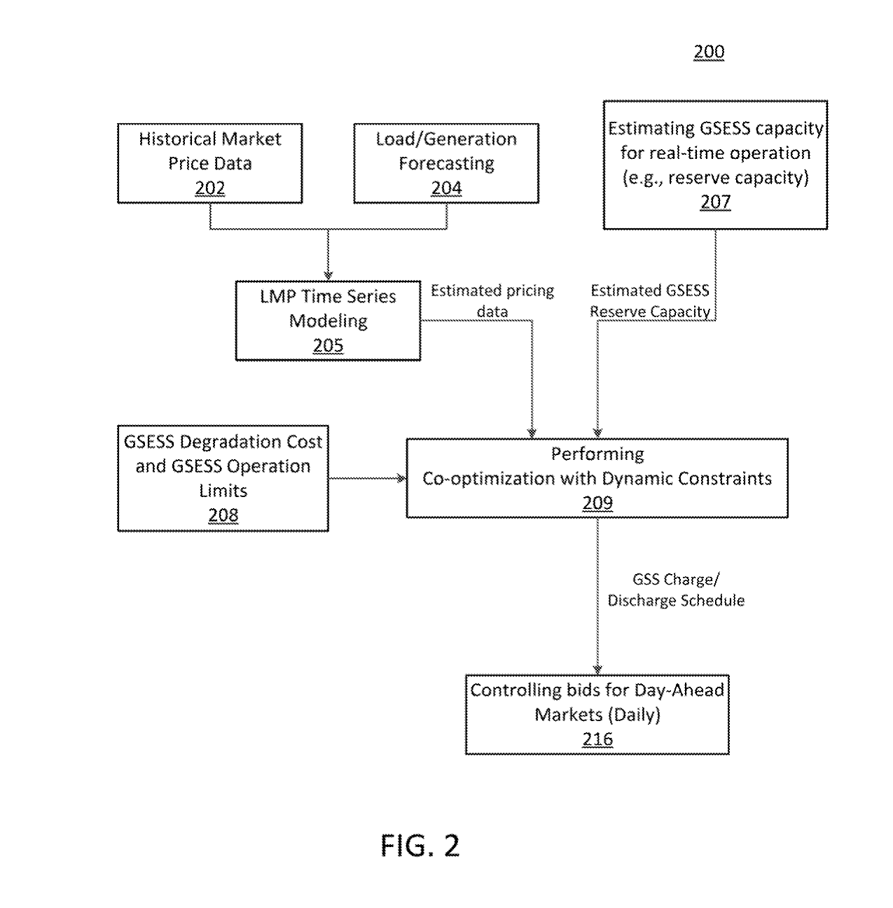

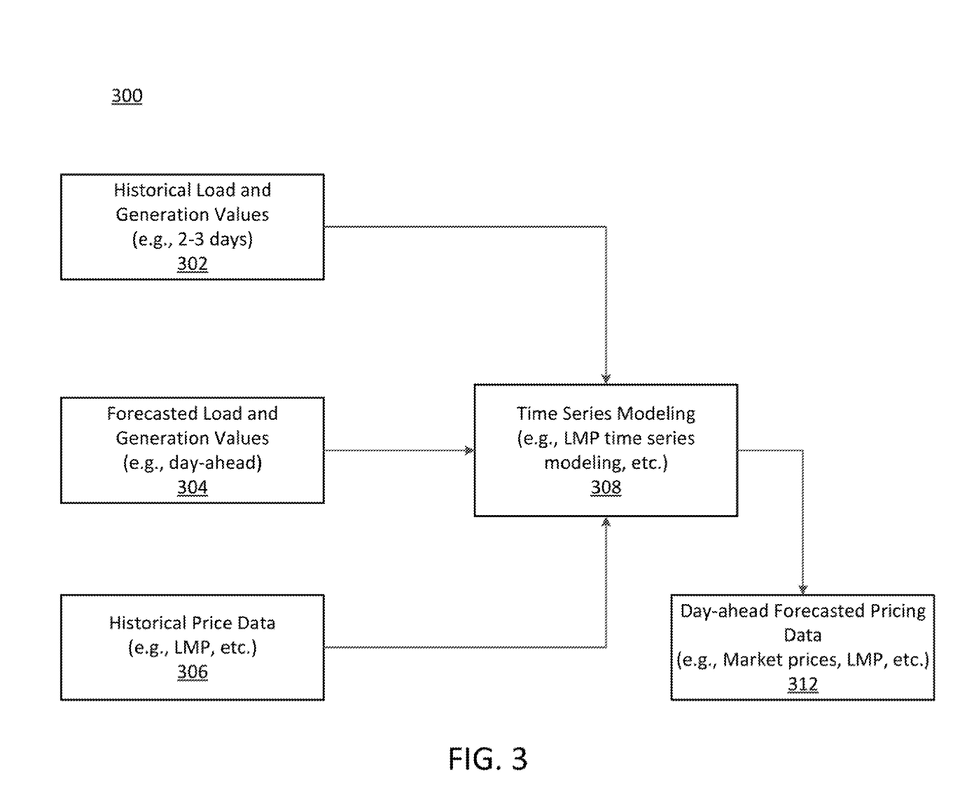

Further, it is to be appreciated that processing system 100 may perform at least part of the method described herein including, for example, at least part of methods 200 and 300 of FIGS. 2 and 3, respectively. Similarly, part or all of systems 400 and 500 with respect to FIGS. 4 and 5, respectively, may be used to perform at least part of methods 200 and 300 of FIGS. 2 and 3, respectively.

Referring now to FIG. 2, a block/flow diagram of a method for dynamically controlling grid scale energy storage systems (GSESS) 200 using mixed-mode management is illustratively depicted in accordance with an embodiment of the present principles. In an embodiment, the method 200 may be employed to determine an optimal grid scale energy storage (GSESS) schedules to participate in multiple markets, including day-ahead energy and Frequency Regulation (FR) markets. A plurality of parameters related to energy market, frequency regulation market, network, and/or GSESS operations may be measured or received according to various embodiments, and may be employed as input for a mixed-mode GSESS management method 200 according to the present principles. The GSESS management method according to the present principles is considered mixed-mode because the method co-optimizes the GSESS for multiple markets, such as an energy market and a frequency regulation market, and enables the GSESS to provide capacity (e.g., a reserve capacity) for real-time services to the grid, such as voltage regulation services according to various embodiments.

To participate in day-ahead markets, users of GSESS units may submit energy bids to market operators prior to the beginning of each day. Thus, the method 200 may determine optimal bids (e.g., energy demands, requirements, requests, etc.) by, for example, performing co-optimization with dynamic constraints in block 209 for the next day. Co-optimizing may include optimizing in a plurality of markets (e.g., energy market, frequency regulation market, voltage regulation market, etc.) rather than optimizing just a single market. These bids may be based on, for example, forecasted pricing data (e.g., forecasted market prices), battery life and degradation costs, and/or estimated reserve capacity, such as real-time voltage regulation operation, according to various embodiments of the present principles.

In an embodiment, historical pricing data 202 (e.g., historical market price data, locational marginal prices (LMP), past energy and/or frequency market price data, historical Independent System Operator (ISO) price data, etc.), historical and/or forecasted load and/or generation profiles/data 204 for the next day may be employed as input for time series modeling (e.g., Locational Marginal Price (LMP) time series modeling) in block 205 to forecast price data according to the present principles. The locational marginal pricing (LMP) is representative of the value of electric energy at different locations, accounting for the patterns of load, generation, and the physical limits of the transmission system. Load and generation profiles represent the total amount of energy that may be stored in the storage unit and the total amount of energy that may be generated from the storage unit, respectively. In an embodiment, a time series based method may be employed for forecasting day-ahead electricity market prices in block 205. The time series modeling in block 205 will be discussed in further detail hereinbelow.

In an embodiment, a reserve capacity of the GSESS unit may be determined (e.g., estimated) in block 207, the reserve capacity being representative of a portion of the GSESS capacity to provide a reserve capacity for real-time operation of services of the GSESS. The GSESS unit may include, for example, any type of energy storage system, including a battery, storage unit, storage tank, accumulators, capacitors, compressed air energy storage, flywheel energy storage unit, thermal energy storage unit, etc. In an embodiment, historical voltage profiles and voltage regulation requirements (e.g., at the point of GSESS connection to the energy grid) 206 may be employed as input to determine (e.g., estimate) the necessary (or desired) GSESS reserve capacity for real-time operation of services during each hour of the next day in block 207. The reserve capacity of the GSESS is estimated to determine whether additional services may be offered without exceeding the total capacity of the GSESS unit.

For example, the GSESS reserve capacity may be estimated to determine whether or not to provide real-time operation services, such as voltage regulation services, peak shaving services, ramp rate control services, etc. Voltage regulation services may include, for example, providing near constant voltage levels and/or regulating the measure of change in the voltage magnitude between the sending and receiving end of a component, such as a transmission line or distribution line, which may be independent of load conditions. Peak shaving services may include, for example, reduction of the amount of peak power on a transmission line, at a substation, or on a feeder. Ramp rate control services may include, for example, services to limit the rate of change in the output generation power of a renewable resource at the point of connection to the grid. The estimated reserve capacity to provide real-time operation services may be considered when generating the optimal bid schedule for multiple market participation in block 209.

In an embodiment, the estimated pricing data from block 205 and the estimated GSESS/battery reserve capacity for real-time operation services (e.g., voltage regulation capacity) from block 206 may be employed as input for performing GSESS/battery co-optimization with dynamic constraints using an optimizer in block 209. For example, the co-optimization in block 209 may consider the reserve capacity to determine whether additional real-time services may be provided to the grid. The co-optimization in block 209 may consider each additional real-time service by considering the revenue of each service and the associated degradation cost of each service.

In an embodiment, GSESS/battery cost and operation limits 208 may also be employed as input into an optimizer for performing co-optimization in block 209. The co-optimization in block 209 may determine optimal GSESS bids for day-ahead market operation, and the bids may be generated and submitted (e.g., daily) to one or more market operators in block 216 according to the present principles. In an embodiment, the optimizer in block 209 may generate an optimal GSESS hourly schedule for market operation.

In block 209, for simplicity of illustration of the co-optimizing, it may be assumed that a GSESS unit is a price taker in both energy and frequency regulation markets according to an embodiment, although co-optimization may be performed in block 209 when a GSESS unit is not a price taker in both energy and FR markets according to various embodiments. In an embodiment, the hourly revenue for the GSESS unit from the markets (Rev) may be determined based on forecasted day-ahead locational marginal prices (LMP) and frequency regulation market prices from block 205 as follows:

Rev(k)=LMP(k)P_{GSESS}^{energy}(k)+λ^{reg}(k)P_{GSESS}^{reg}(k) (1)

where LMP(k) is the locational marginal price at hour k, P_{GSESS}^{energy} is hourly power of the GSESS at hour k, λ^{reg} is forecasted frequency regulation price at hour k, and P_{GSESS}^{reg} is GSESS capacity in a frequency regulation market at hour k. In an embodiment, it may be assumed that the GSESS provides equal regulation of up and down capacity during each hour of operation in the FR market. In an embodiment, the up and down capacity may include frequency regulation up and frequency regulation down capacities, which may be the same as the GSESS schedule for the FR market. For simplicity of illustration, they may be assumed to be equal, and may be determined in the co-optimization by solving for P_{GSESS}^{reg} in (1). Therefore, only one FR regulation capacity and one FR price for each hour may be considered in (1) by the optimizer in block 209 according to an embodiment of the present principles.

In an embodiment, the co-optimization in block 209 may include modeling the hourly degradation cost using a battery life/degradation cost determination device according to the present principles. Degradation cost generally refers to the cost of the GSESS unit resulting from the shortening of the life cycle. Grid scale energy storage systems, including those which utilize batteries, have a limited life cycle and each charge and discharge action will reduce and/or degrade the life cycle of the GSESS to some extent. After the GSESS's life cycle has been diminished, portions of the GSESS may need to be replaced, of which the cost for the replacement is considered an operating cost of the storage system and is expensive.

To model the hourly degradation cost (Cost) of a GSS unit when participating in the market, an average model based on per unit degradation cost of GSESS multiplied by its energy throughput may be generated as follows:

Cost(k)=C_{b}|P_{GSESS}^{energy}(k)|+C_{b}P_{GSESS}^{reg}(k) (2)

where C_{b} is the GSESS per unit degradation cost. Thus, the hourly degradation cost (Cost) of a GSESS unit when participating in multiple markets is the per unit degradation cost in the energy market P_{GSESS}^{energy} (k) at time k plus the per unit degradation cost in the frequency regulation market P_{GSESS}^{reg}(k) at time k. In an embodiment, scheduled power in the energy market can assume both positive and negative values depending on the charge/discharge state of GSESS, while scheduled capacity in FR market may always be a positive value. Thus, the absolute value function may be applied only to the first term of the rate-harmonized scheduling (RHS) described in (2).

In an embodiment, the objective function of market co-optimization in block 209 may be considered in terms of daily net revenue as follows:

$$max {\sum }_{k = 1}^{24} ( Rev ( k ) - Cost ( k ) ) \qquad ( 3 )$$

The daily net revenue may be the summation of the total hourly revenue (Rev) at hour k from the multiple markets reduced by the hourly degradation cost (Cost) of the GSESS at time k. Advantageously, estimating the GSESS wear cost in each market may prevent any financial losses or impact on the optimal schedule of the GSESS in multiple markets. For example, if the degradation cost is higher than the total revenue, operation of the GSESS may be stopped or interrupted to avoid any financial loss.

In an embodiment, the objective function of market co-optimization in block 209 may be subject to operation limits 208, such as constraints related to limited energy and power capacity of the GSESS unit. Generally, energy is related to the volume or amount of energy that may be supplied and received into a power grid, and power is related to the rate of flow at which the system can supply and receive energy.

In embodiment, one constraint may include State of Charge (SoC). State of charge (SOC) refers to the electric energy content and corresponding energy content limits of the GSESS, such as a maximum energy content (e.g., maximum SoC, SoCₘₐₓ) and a minimum energy content (e.g., minimum SoC, SoCₘᵢₙ) of the GSESS. Thus, when the GSESS is completely charged the maximum SoC of the GSESS may be one hundred percent full. Alternatively, when the GSESS is completely discharged the minimum SoC of the GSESS may be zero percent full (e.g., empty). In an embodiment, the objective function of market co-optimization in block 209 may be subject to SoC constraints, wherein the SoC constraint of the GSESS at hour k may be represented by:

SoCₘᵢₙ(k)≦SoC(k)≦SoCₘₐₓ(k). (4)

In an embodiment, the state of charge (SoC) of the GSESS may be determined as follows:

$$SoC ( k ) = SoC ( k - 1 ) - \frac{{P}_{GSESS}^{energy} ( k )}{{E}_{GSESS}} , \qquad ( 5 )$$

where E_{GSESS} represents the energy capacity of the GSESS. The maximum and minimum values of state of charge (SoC), namely SoCₘₐₓ(k) and SoCₘᵢₙ(k) are dependent on time (k) so that in each hour they can be adjusted based on voltage regulation requirements according to an embodiment of the present principles.

In one embodiment, the objective function of market co-optimization in block 209 may be subject to power capacity constraints. For example, one constraint may include the minimum and maximum power capacity constraints of the GSESS in each market. The power capacity constraints of the GSESS in the energy market (P_{GSESS}^{energy}) at time k may be represented by:

−P_{GSESS}^{max}(k)≦P_{GSESS}^{energy}(k)≦P_{GSESS}^{max}(k) (6)

where P_{GSESS}^{max}(k) represents the maximum power capacity at time k of the GSESS and P_{GSESS}^{max}(k) represents the minimum power capacity at time k of the GSESS.

In an embodiment, the power capacity constraints of the GSESS in the frequency regulation market (P_{GSESS}^{reg}) may be represented by:

P_{GSESS}^{energy}(k)+P_{GSESS}^{reg}(k)≦P_{GSESS}^{max}(k), (7)

−P_{GSESS}^{energy}(k)+P_{GSESS}^{reg}(k)≦P_{GSESS}^{max}(k). (8)

The maximum GSESS power (P_{GSESS}^{max}(k)) is dependent on time (k) so that in each hour it can be adjusted based on voltage regulation requirements according to an embodiment of the present principles.

In an embodiment, multiple market co-optimization may be performed in block 209, and a sample objective function for day-ahead energy and regulation markets may be illustrated as follows:

$$max {\sum }_{h = 1}^{24} ( LMP [ k ] \times {P}_{GSESS}^{energy} [ k ] + {λ}^{reg} [ k ] \times {P}_{GSESS}^{reg} [ k ] - {C}_{b} \times \vert {P}_{GSESS}^{energy} [ t ] \vert - {C}_{b} \times {P}_{GSESS}^{reg} [ k ] ) , \qquad ( 9 )$$

where LMP[k] represents the locational marginal price at k-th time-step (e.g., at h hour), P_{GSESS}^{energy} represents the GSESS power (schedule) in day-ahead energy market, λ^{reg} represents the estimated frequency regulation market price, P_{GSESS}^{reg} represents the GSESS power (schedule) in day-ahead frequency regulation market, and C_{b} represents the battery degradation/wear cost.

In an embodiment, LMP[k]×P_{GSESS}^{energy}[k] represents the forecasted revenue from the energy market at time k, λ^{reg}[k]×P_{GSESS}^{reg}[k] represents the forecasted revenue from the frequency regulation market at time k, C_{b}×|P_{GSESS}^{energy}[t]| represents the GSESS wear cost in the energy market at time k, and C_{b}×P_{GSESS}^{reg}[k] represents the GSESS wear cost in the frequency regulation market at time k. Thus, the co-optimization formulation in block 209 may be represented as the summation of forecasted prices at the energy market, forecasted prices at the frequency regulation market minus battery wear cost in both the energy market and the frequency regulation market.

In an embodiment, the revenue from the energy market, the revenue from the frequency regulation market, and battery wear cost in both the energy market and the frequency regulation market may be subject to dynamic constraints/limits (e.g., state-of-charge (SOC) limits, maximum charge and discharge power limits, etc.), and the consideration of the battery wear cost may enable maximization of total net revenue according to the present principles.

In an embodiment, the co-optimization in block 209 may consider additional real-time services based on the reserve capacity for real-time operation of services determined in block 207. Real-time GSESS services include various services of the GSESS that may be provided in real-time operation, such as voltage regulation, peak shaving, ramp rate control, etc. The objective function may consider each additional real-time service by considering the revenue of each service and the associated degradation cost of each service during the co-optimization in block 209. In an embodiment, the objective function during the co-optimization in block 209 may include adjusting the co-optimization constraints to enable the reserve capacity for real-time operation services. For example, the minimum and maximum State of Charge (SoCₘᵢₙ(k),SoCₘₐₓ(k)) and/or maximum power (P_{GSESS}^{max}(k)) constraints for each time-step may be adjusted such that enough capacity (e.g., a reserve capacity) for real-time operation services is available (e.g., provided) for the GSESS unit. Hence, the GSESS market operation does not interfere with providing real-time services to the grid, although both might happen simultaneously.

The objective function of market during co-optimization in block 209 may determine optimal GSESS bids for day-ahead market operation, and the bids may be generated and submitted (e.g., daily) to one or more market operators in block 216 according to the present principles.

Referring now to FIG. 3, an exemplary method for forecasting pricing data (e.g., day-ahead prices) in a plurality of markets 300 is illustratively depicted in accordance with an embodiment of the present principles. In an embodiment, the method 300 may employ a plurality of inputs, including, historical load and/or generation values (e.g., 2-3 days) from block 302, forecasted load and/or generation values (e.g., 2-3 days) from block 304, and historical pricing data (e.g., LMP, etc.) from block 308.

In an embodiment, the plurality of inputs in blocks 302, 304 and/or 306 may be employed as input for the time series modeling (e.g., time series forecasting) in block 308. An illustrative example of a time series model according to an embodiment is the following:

P(t+1)=a₁P(t)+a₂P(t−1)+a₃P(t−2)+b₁ P̅(t)+b₂ P̅(t−1)+c₁X(t)+c₂X(t−1)+ε(t), (10)

where P is a price (e.g., LMP, frequency regulation price), and P̅ is the moving average considering a fixed number of steps back. The price forecast P(t+1) may also be a function of the past (e.g., historical) values of exogenous inputs (X(t), X(t−1)). In an embodiment, inputs which are functions of historical values of load and generation 302, as well as functions of load forecasts 304 may be employed during time series modeling in block 308 to generate day-ahead forecasted pricing data in block 310 according to the present principles.

Referring now to FIG. 4, an exemplary system and method for control of grid scale energy storage systems (GSESSs) 400 is illustratively depicted in accordance with an embodiment of the present principles. In an embodiment, one or more GSESSs may be controlled using a controller 404 for optimal battery dispatch in accordance with the present principles.

In an embodiment, one or more GSESSs 402 may be controlled using a controller 404 for optimization and determining and submitting daily bids for day-ahead energy markets in accordance with the present principles. Independent System Operator (ISO) data may be input in block 401, and a forecaster 408 may be employed for time series forecasting to determine a profile of future ISO signals. In an embodiment, historical pricing data (e.g., historical market price data), historical and/or forecasted load and/or generation profiles/data for the next day may be employed as input for the Independent System Operator (ISO) data in block 401. The output of the forecaster 408 and historical battery data 403 may be employed as input to a life estimator 410 to determine an optimal battery dispatch schedule. The life estimator 410 may calculate the life impact of the providing of the forecasted ISO service, and the output of the life estimator may be employed for optimization (e.g., stochastic dispatch optimization) in block 412. Stochastic optimization in block 412 may evaluate a cost tradeoff of providing the ISO service versus battery life cost for a plurality of situations to determine the optimal battery dispatch according to the present principles. The output of the optimization in block 412 may be employed for command controlling/dispatching in block 414.

In an embodiment, the forecaster 408 may employ LMP forecasting for forecasting pricing data (e.g., day-ahead pricing data, electricity market prices). Offline simulations may be employed to estimate optimal battery size and/or reserve capacity (e.g., if not provided by service provider), and the life estimator 410 may evaluate the real-time cost of all services, enabling the services to be provided in the most economical way without compromising battery life. The life estimator 410 may ascertain safe operating parameters and discharge limits of the GSESS (e.g., State of Charge constraints, power constraints, etc.) to generate auction bids and derive favorable operational conditions for the GSESS. The forecaster 408 and life estimator 410 may be employed to proactively provision battery resources between usable and reserved allocations for day-ahead, hour-ahead, and real-time markets according to various embodiments using the controller 404 according to the present principles.

FIG. 5 shows an exemplary system for dynamically controlling Grid Scale Energy Storage Systems (GSESSs) 500, with continued reference to FIG. 2, in accordance with an embodiment of the present principles. While many aspects of system 500 are described in singular form for the sake of illustration and clarity, the same can be applied to multiples ones of the items mentioned with respect to the description of system 500. For example, while a single optimizer 504 is described, more than one optimizer 504 can be used in accordance with the teachings of the present principles, while maintaining the scope of the present principles. Moreover, it is appreciated that the optimizer 504 is but one aspect involved with system 500 than can be extended to plural form while maintaining the scope of the present principles.

The system 500 may include a forecaster 502, an optimizer 504, a capacity determiner 506, a storage device 508, a controller 510, a battery life/degradation cost determiner 512, and a time series modeler 514.

In an embodiment, the forecaster 502 may forecast and provide forecasted pricing data and/or load and/or generation profiles/data for day-ahead energy markets (as described above with reference to FIG. 2), and the forecasts may be stored in a storage device 508, and may be input into a time series modeler 514 for LMP time series modeling (as described above with reference to FIG. 2) according to various embodiments. The forecaster 502 may forecast load and/or generation profiles/data for day-ahead energy markets using historical pricing data (e.g., historical market price data), historical and/or forecasted load and/or generation profiles/data for the next day as input for the time series modeling to forecast market prices according to the present principles.

The capacity determiner 506 may be configured to estimate the GSESS reserve capacity for real-time operation of services during each hour of the next day, such as voltage regulation services, peak shaving services, ramp rate control services, etc. In an embodiment, the capacity determiner 506 may estimate the GSESS's reserve capacity to determine whether additional services may be offered without exceeding the total capacity of the GSESS unit. For example, the capacity determiner 506 may be configured to estimate the reserve capacity in a GSESS. In an embodiment, the output of the capacity determiner 506 may be employed as input for co-optimization (as described above with reference to FIG. 2) using the optimizer 504.

In an embodiment, a battery life/degradation cost determiner 512 may be employed to determine GSS/battery costs and operation limits, and the output of the time series modeler 514 and the determiner 512 may be employed as input for co-optimization (as described above with reference to FIG. 2) using the optimizer 504. In an embodiment, the battery life/degradation cost determiner 512 may be configured to determine GSS/battery costs and operation limits prior to co-optimization using the optimizer 504.

The optimizer 504 may be configured to optimize energy bids for day-ahead. In one embodiment, the optimizer 504 may optimize energy bids for day-ahead based on the forecasted pricing data (e.g., forecasted energy market prices) generated by the forecaster 502, battery degradation costs determined by the battery life/degradation cost determiner 512, and/or the voltage regulation capacity determined by the capacity determiner 506 for the one or more GSESSs. In an embodiment, the optimizer 504 may evaluate a cost tradeoff of providing the ISO service versus battery life cost for a plurality of situations to determine the optimal battery dispatch according to the present principles. In another embodiment, the optimizer 504 may be configured to adjust the co-optimization constraints. For example, the optimizer 504 may be configured to adjust the minimum and maximum State of Charge (SoCₘᵢₙ(k),SoCₘₐₓ(k)) and/or maximum power (P_{GSESS}^{max}(k)) constraints for each time-step such that enough capacity (e.g., a reserve capacity) for real-time operation services is available for the GSESS unit. The output of the optimizer 504 may be employed for command controlling/dispatching.

In an embodiment, the controller 510 may control distribution of energy to or from the one or more GSESSs based on the optimal bids generated by the optimizer 504. In some embodiments, the controller 510 may be a virtual appliance (e.g., computing device, node, server, etc.), and may be directly connected to an GSESS or located remotely for controlling via any type of transmission medium (e.g., Internet, intranet, internet of things, etc.). In some embodiments, the controller 510 may be a hardware device, and may be attached to a GSESS or built into an GSESS, according to the present principles.

In the embodiment shown in FIG. 5, the elements thereof are interconnected by a bus 501. However, in other embodiments, other types of connections can also be used. Moreover, in one embodiment, at least one of the elements of system 500 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 500 are readily determined by one of ordinary skill in the art, given the teachings of the present principles provided herein, while maintaining the spirit of the present principles.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope of the invention.

What is claimed is:

1. A computer implemented method for controlling operation of one or more grid scale energy storage systems (GSESSs), comprising:
generating at least one time series model to provide forecasted pricing data for a plurality of markets;
determining a reserve capacity for the one or more GSESSs to provide one or more real-time operation services;
determining battery life and degradation costs for one or more batteries in the one or more GSESSs to provide battery life and degradation costs; and
optimizing bids for the plurality of markets to generate optimal bids based on at least one of the forecasted pricing data, the battery life and degradation costs and the reserve capacity.

2. The method of claim 1, wherein the forecasted pricing data includes at least one of forecasted energy market prices and forecasted frequency regulation market prices.

3. The method of claim 1, wherein the one or more real-time operation services includes at least one of voltage regulation services, peak shaving services, and ramp rate control services.

4. The method of claim 1, wherein the at least one time series model includes a Locational Marginal Price (LMP) time series model.

5. The method of claim 1, wherein the determining battery life and degradation costs further comprises generating an average model based on per unit degradation costs of each GSESS multiplied by the energy throughput of the GSESS.

6. The method of claim 1, wherein the optimizing further comprises stochastic optimization to evaluate a cost tradeoff of providing energy services versus battery life costs for a plurality of situations to determine an optimal battery dispatch.

7. The method of claim 1, wherein the bids are day-ahead energy bids.

8. A system for controlling operation of one or more grid scale energy storage systems (GSESSs), the system comprising:
a forecaster configured to generate at least one time series models to provide forecasted pricing data for a plurality of markets;
a capacity determiner configured to determine a reserve capacity or the one or more GSESSs to provide one or more real-time operation services;
a battery life/degradation cost determiner configured to determine battery life and degradation costs for one or more batteries in the one or more GSESSs to provide battery life and degradation costs; and
an optimizer configured to generate optimal bids based on at least one of the forecasted pricing data, the battery life and degradation costs and the reserve capacity.

9. The system of claim 8, wherein the forecasted pricing data includes at least one of forecasted energy market prices and forecasted frequency regulation market prices.

10. The system of claim 8, wherein the one or more real-time operation services includes at least one of voltage regulation services, peak shaving services, and ramp rate control services.

11. The system of claim 8, wherein the at least one time series model includes a Locational Marginal Price (LMP) time series model.

12. The system of claim 8, wherein the battery life/degradation cost determiner is further configured generate an average model based on per unit degradation costs of each GSESS multiplied by the energy throughput of the GSESS.

13. The system of claim 8, wherein the optimizer is further configured to optimize energy bids for day-ahead using a stochastic optimization to evaluate a cost tradeoff of providing energy services versus battery life costs for a plurality of situations to determine an optimal battery dispatch.

14. The system of claim 8, wherein the bids are day-ahead energy bids.

15. A computer-readable storage medium comprising a computer readable program, wherein the computer readable program when executed on a computer causes the computer to perform the steps of:
generating at least one time series model to provide forecasted pricing data for a plurality of markets;
determining a reserve capacity for the one or more GSESSs to provide one or more real-time operation services;
determining battery life and degradation costs for one or more batteries in the one or more GSESSs to provide battery life and degradation costs; and
optimizing bids for the plurality of markets to generate optimal bids based on at least one of the forecasted pricing data, the battery life and degradation costs and the reserve capacity.

16. The computer-readable storage medium of claim 15, wherein the forecasted pricing data includes at least one of forecasted energy market prices and forecasted frequency regulation market prices.

17. The computer-readable storage medium of claim 15, wherein the one or more real-time operation services includes at least one of voltage regulation services, peak shaving services, and ramp rate control services.

18. The computer-readable storage medium of claim 15, wherein the at least one time series model includes a Locational Marginal Price (LMP) time series model.

19. The computer-readable storage medium of claim 15, wherein the determining battery life and degradation costs further comprises generating an average model based on per unit degradation costs of each GSESS multiplied by the energy throughput of the GSESS.

20. The computer-readable storage medium of claim 15, wherein the optimizing further comprises stochastic optimization to evaluate a cost tradeoff of providing energy services versus battery life costs for a plurality of situations to determine an optimal battery dispatch.
